(19) United States
(12) Patent Application Publication
(10) Pub. No.: US 2007/0033118 A1
(43) Pub. Date: Feb. 8, 2007

(54) Document Scanning and Data Derivation Architecture.

(75) Inventor: Christopher Miles Hopkinson, Baltimore, MD (US)

Correspondence Address: TaxScan Technologies, LLC, 4 Professional Drive, Suite 126, Gaithersburg, MD, 20879, US

(73) Assignee: TaxScan Technologies, LLC, Gaithersburg, MD (US)

(21) Appl. No.: 11/461,785

(22) Filed: Aug. 2, 2006

Related U.S. Application Data
(60) Provisional application No. 60/704,457, filed on Aug. 2, 2005.

(51) Int. Cl. G06F 17/22; G06K 9/00

(52) U.S. Cl. 705/31; 382/181

(57) ABSTRACT

Proprietary suite of underlying document image analysis capabilities, including a novel forms enhancement, segmentation and modeling component, forms recognition and optical character recognition. Future version of the system will include form reasoning to detect and classify fields on forms with varying layout. Product provides acquisition, modeling, recognition and processing components, and has the ability to verify recognized data on the image with a line by line comparison. The key enabling technologies center around the recognition and processing of the scanned forms. The system learns the positions of lines and the location of text on the pre-printed form, and associates various regions of the form with specific required fields in the electronic version. Once the form is recognized, the preprinted material is removed and individual regions are passed to an optical character recognition component. The current proprietary OCR engine is trained with a variety of Roman text fonts and has a back end dictionary that can be customized to account for the fact that the system knows which field it is recognizing. The engine performs segmentation to obtain isolated characters and computes a structure based feature vector. The characters are normalized and classified using a cluster centric classifier, which responds well to variations in the symbols contour. An efficient dictionary lookup scheme provides exact and edit distance lookup using a TRIE structure. An edit distance is computed and a collection of near misses can be output in a lattice to enhance the final recognition result. The current classification rate can exceed 99% with context. The ultimate goal of this system is to enable the processing of all tax forms including forms with handwritten material.

### INVENTION BACKGROUND

The product and idea were created by the founding partners of a tax and accounting firm looking to build a better way to prepare and process tax returns during the busy tax season.

The basic concept of the invention is a better, faster and error free way to capture, collect, process and prepare the tax data information used to file a business or individual tax return.

The tax filing process has changed dramatically over the last decade. The IRS receives over 70 million returns electronically (Internal Revenue Service: ‘2006 Filing Season Statistics through Apr. 12, 2006’). Refunds can be directly deposited in as little as two days and popular tax preparation software programs are replacing paper forms; 116.5 million returns were prepared on a computer in 2004 (Internal Revenue Service: ‘2004 Taxpayer Usage Study Report Number 14’).

Despite these improvements, little has been done to improve the lengthy preparation process. According to IRS statistics, it takes the average taxpayer over 14 hours to complete IRS form 1040 and can take up to 44 hours if you're adding Schedules A, B, C, D and E (‘Why the tax system drives me—and you—crazy,’ MSN Money 2005).

The tax preparation process is not only time consuming, but also costly. The estimated annual tax compliance total cost to individuals is over $110 million. The total cost to business is over $147 million (‘Estimated Cost to Individuals of the Federal Income Tax System by Type of Form Calendar Year 2005’ and ‘Estimated Cost to Business of the Federal Income Tax System by Type of Form Calendar Year 2005,’ The Tax Foundation and Internal Revenue Service). Tax compliance refers to the basic actions required to file a federal income tax return including; recordkeeping, education, form preparation and packaging/sending (ibid).

Costs are also increasing at tax preparation or accounting firms who employ data entry processors to manually type and prepare individual and business tax returns.

In addition, according to the Internal Revenue Service, numerical errors (such as miscalculations or typographical errors) and incorrect Social Security numbers are the two most common mistakes on tax returns (‘Last-Minute Tax Mistakes: Five Things You Should Know,’ InCharge® Education Foundation, Inc. 2004).

### SUMMARY

The goal of the invention is to significantly reduce or eliminate the manual typing of tax data from standard IRS tax forms (W-2, 1099, 1098, etc.) into a computer or on paper.

Another goal of the invention is to eliminate or reduce common typographical errors and reduce the time and cost of tax compliance for both the individual and professional preparer.

These goals are achieved by the creation of a software product that uses a combination of Optical Character Recognition (OCR) and data derivation technology to read, recognize and capture information from a scanned or digitally captured document, such as Internal Revenue Service line items from any scanned or digitally captured tax document (W-2, 1099, 1098, etc.). An exemplary embodiment of product then imports the specific captured information directly into tax preparation software (such as TurboTax®) or ProSystems®).

The exemplary embodiment of product at least eliminates the need to manually enter standard tax information saving valuable time, eliminating common data entry errors and allowing for the documents to be digitally saved and stored rather than kept in bulky filing systems.

For purposes of explanation, numerous details are set forth in order to provide a thorough understanding of the present invention. It should be appreciated however, that the present invention may be practiced in a variety of ways beyond the specific details set forth herein. For example, the systems and methods of this invention can generally be applied to any type of document within any environment and the data captured therefrom exported to any application or storage facility. Additionally, scanned versions of the document(s) can be stored in optical form and, for example, linked to the derived information via a hyperlink such that verification of the derived information can be performed.

Furthermore, while the exemplary embodiments illustrated herein show the various components of the system collocated in specific locations, it is to be appreciated that the various components of the system can be located or relocated at distant portions of a distributed network, such as a telecommunications network and/or the Internet, or within a dedicated secure, unsecured and/or encrypted system. Thus, it should be appreciated that the components of the system can be combined into one or more devices, such as a scanner, or collocated on a particular node of a distributed network, such as a telecommunications network. As will be appreciated from the following description, and for reasons of computational efficiency, the components of the system can be arranged at any location within a distributed network without affecting the operation of the system.

### BRIEF DESCRIPTION OF THE DRAWINGS

FIG. 1 illustrates the procedure of the invention.

FIG. 2 illustrates how the Form ID Template and Document Template could be used to identify a form and then extract information therefrom.

### DETAILED DESCRIPTION OF THE INVENTION

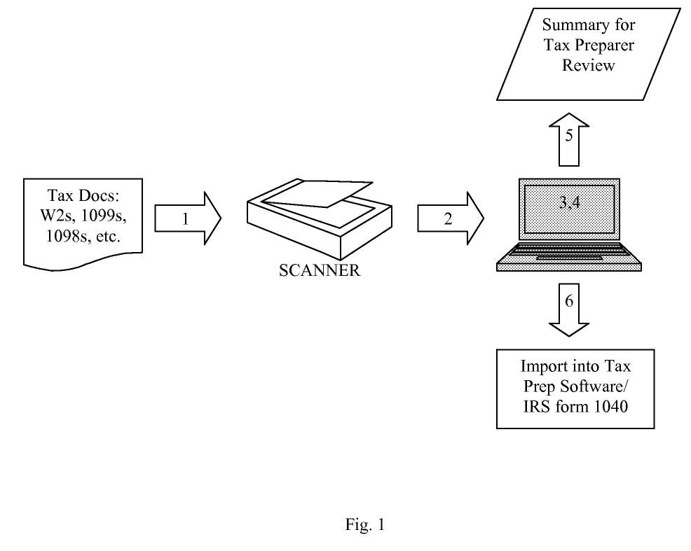

Referring to FIG. 1.

Step 1) In accordance with an exemplary embodiment, the first step is to scan the tax documents (i.e. W-2, 1099, 1098 or any document relevant to, for example, tax filing) using a scanner connected to a PC. Other documents that could be scanned include but are not limited to: charitable receipts or checks, auto mileage logs, credit card statements, any deductible business receipts or worksheets including; meals and entertainment, cell phone, computer, fax and other deductible receipts and IRS Schedules B, C, D and F. While the invention will be described in relation to a tax forms and software, in general, any document can be scanned that would be applicable to the operating environment of the system. OCR technology reads the data from the scanned tax documents.

Step 2) An exemplary embodiment of the product then searches the recognized document for standardized IRS form headings (W-2, 1099, 1098, etc.). These form headings are found in specific locations of the forms and can be recognized by the product when, for example, compared to a form ID template list that indicates the placement and content of the form headings. This template, when used in conjunction with OCR will allow the product to identify the document type.

Step 3) Based on document type, the product determines what information is required from the form for tax filing purposes and searches for this information (name, Social Security number, address and necessary box or line items). As with the form headings, by using the document template, the location, field, type of data for extraction and extraction location can be specified. Utilizing this information the product can also control the scanner to extract specific information from specific location(s) of a document.

Step 4) The product will read and capture the required information from each box or line item on the form. For example, on a W-2 form, the product will recognize and capture Box 1 as wages, tips and other compensation from this employer. On a 1099-DIV form, the product will recognize and capture Line 1A as total ordinary dividends from this institution.

Step 5) Once the form has been scanned and box or line items captured, the product will store in a database and tabulate a running summary of the tax documents and information for review.

Step 6) After the final document has been scanned and tax information reviewed, product can export the data from its database into a file format (.txf, ascii, text, XML, etc.) and/or export the data directly into tax preparation software (such as TurboTax®) or directly into Internal Revenue Service form 1040 for final review before filing.

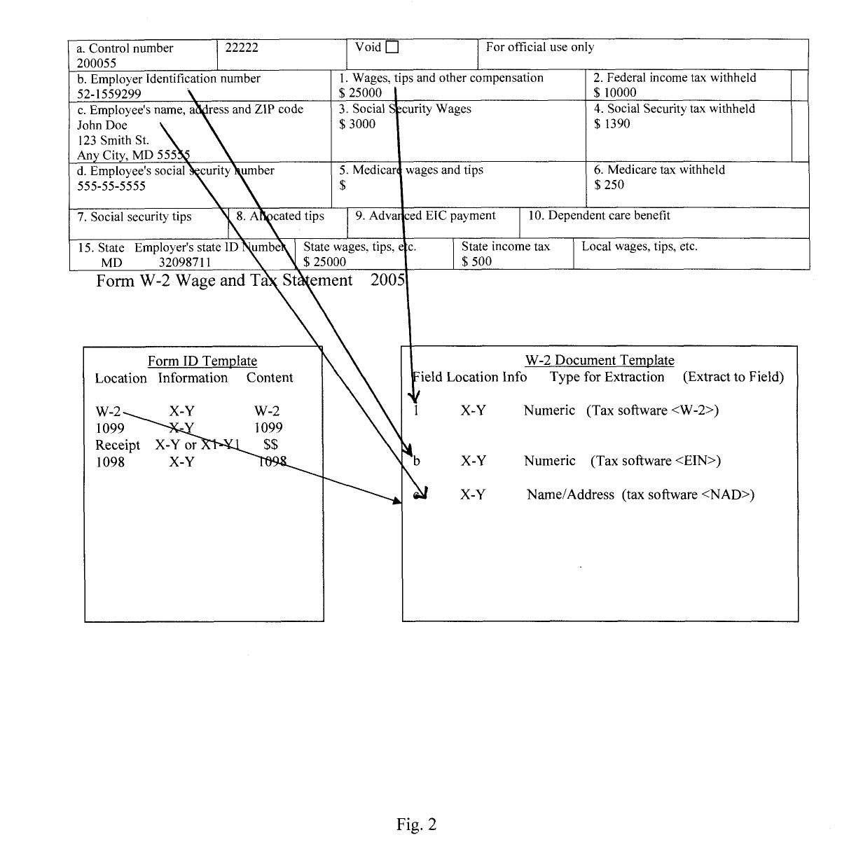

Referring to FIG. 2.

The form ID template can be used for form identification. For example, the Form ID Template could include location information, for example, X-Y coordinates, where certain information is located. A document could then be scanned and information found at the specified coordinates compared to the Form ID Template for a match. Unidentified forms could also be added to the Form ID Template database specifying, for example, location and content information that would allow identification of the form.

The Document Template is used once the document is identified to extract information from the scanned and recognized document. For example, the document template could contain field information, location information for where the data is to be extracted from, e.g., in X-Y coordinate format, the type of information for extraction, e.g., alphabetical, numerical, graphical, etc., and the export location for the derived data, such as a field name or a database.

The above-described communication system can be implemented on a computer or on a separate programmed general purpose computer having a scanner. Additionally, the systems and methods of this invention can be implemented on a special purpose computer, a programmed microprocessor or microcontroller and peripheral integrated circuit element(s), an ASIC or other integrated circuit, a hard-wired electronic or logic circuit such as discrete element circuit, a programmable logic device such as PLD, PLA, FPGA, PAL, or the like. In general, any device capable of implementing a state machine that is in turn capable of implementing the methodology illustrated herein can be used to implement the various methods and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and method illustrated herein however can be readily implemented in hardware and/or software using any known or later developed systems or structures, devices and/or software by those of ordinary skill in the applicable art from the functional description provided herein and with a general basic knowledge of the computer arts.

Moreover, the disclosed methods may be readily implemented in software executed on programmed general purpose computer, a special purpose computer, a microprocessor, or the like. In these instances, the systems and methods of this invention can be implemented as program embedded on personal computer such as JAVA® or CGI script, as a resource residing on a server or computer workstation, as a routine embedded in a dedicated scanning and extraction system, or the like. The system can also be implemented by physically incorporating the system and/or method into a software and/or hardware system, such as the hardware and software systems of a dedicated scanner.

Additionally, product can read one or more machine readable portions of a document, such as a bar code, and retrieve information from the machine readable portions that can then be output to, for example, tax preparation software and/or stored in a database. It is therefore apparent that there has been provided, in accordance with the present invention, systems and methods for extracting information from documents. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. Tax form and data document scanning and derivation; tax form, box and line item; recognition, capture, extraction and processing architecture:
means to recognize scanned Internal Revenue Service (“IRS”) tax form(s); and
means to capture identification of scanned Internal Revenue Service tax form(s); and
means to organize scanned Internal Revenue Service tax form(s) electronically
means to recognize scanned IRS form(s) line and box item(s) data from recognized and captured scanned IRS form(s); and
means to capture scanned IRS form(s) line and box item(s); and
means to extract scanned IRS form(s) line and box item(s) into computer, electronic file or other tax preparation software or process.
means to import scanned box and line item information directly into IRS form 1040 for filing.

2. Technology as in claim 1, wherein said means gathering tax form(s) for recognition, capture, extraction and processing technology is a scanner or other digital capture device.

3. Technology as in claim 1, wherein said tax data is reported on IRS federal, state, local or foreign tax form.

4. Technology as in claim 3, wherein IRS tax form(s) captured and identified include IRS Form W-2.

5. Technology as in claim 3, wherein IRS tax form(s) captured and identified include IRS Form(s) 1099.

6. Technology as in claim 3, wherein IRS tax form(s) captured and identified include IRS Form(s) 1098.

7. Technology as in claim 4, wherein line and box items recognized, extracted and processed include all line and box items found on IRS Form W-2.

8. Technology as in claim 5, wherein line and box items recognized, extracted and processed include all line and box items found on IRS Form 1099.

9. Technology as in claim 6, wherein line and box items recognized, extracted and processed include all line and box items found on IRS Form 1098.

10. A method for digitally organizing scanned tax form(s).

11. A method as in claim 10, wherein tax form(s) organized include Internal Revenue Service Form W-2.

12. A method as in claim 10, wherein tax form(s) organized include Internal Revenue Service Form(s) 1099.

13. A method as in claim 10, wherein tax form(s) organized include Internal Revenue Service Form(s) 1098.

14. A method for organizing scanned tax form data line and box item information.

15. A method as in claim 14, wherein said tax data is reported on an Internal Revenue Service (“IRS”) federal, local, state or foreign tax forms.

16. A method for transferring scanned tax data into Internal Revenue Service form 1040.

17. A method as in claim 13 for transferring scanned tax data into Internal Revenue Service form 1040-A.

18. A method as in claim 13 for transferring scanned tax data into Internal Revenue Service form 1040-EZ.

19. A method as in claim 13 for transferring scanned tax data into Internal Revenue Service form 1040-C.

20. A method as in claim 13 for transferring scanned tax data into Internal Revenue Service form 1040-SS.

21. A method as in claim 13 for transferring scanned tax data into Internal Revenue Service form 1040-NR.

22. A method for transferring scanned tax data into tax preparation software; such as TurboTax®, ProSystems®, TaxCut®, any other similar tax preparation programs.
